(19) United States
(12) Patent Application Publication
(10) Pub. No.: US 2019/0216040 A1
(43) Pub. Date: Jul. 18, 2019

(54) PET STATION

(71) Applicant: Ginamarie Ferrara, Wainscott, NY (US)

(72) Inventor: Ginamarie Ferrara, Wainscott, NY (US)

(21) Appl. No.: 15/914,214

(22) Filed: Mar. 7, 2018

Related U.S. Application Data
(60) Provisional application No. 62/617,536, filed on Jan. 15, 2018.

(51) Int. Cl. A01K 1/01

(52) U.S. Cl. CPC A01K 1/011; A01K 1/0142

(57) ABSTRACT

A system for receiving, maintaining and disposing of waste from domesticated animals has an upper section formed of sheet material that defines an inner volume for holding and receiving litter and a bottom section that operates to support the upper section. The lower section includes an opening for access to inner volume of the lower section. A plate may be inserted in an opening between the inner volume of the upper section and the inner volume of the lower section, to form a bottom and lower boundary of the inner volume of the upper section. Upon removing the plate, any litter, waste and other debris present in the inner volume of the top section falls or drops into the inner volume of the bottom section.

### CROSS-REFERENCE TO RELATED APPLICATIONS

This application claims priority under 35 USC § 119(e) from U.S. Provisional Patent Application No. 62/617,536, filed Jan. 15, 2018, the content of which provisional application is incorporated herein by reference.

### BACKGROUND OF THE INVENTION

The invention relates to a pet station for accommodating pet waste, typically, but not limited to, the use by cats and dogs.

Pets stations have developed as a convenience to pet owners. What cat or dog owner cannot gripe, at least mildly, about walking his or her feline or canine companion in the rain, sleet, and snow, whether during daylight hours or in the dark of night? The alternative, of course, are pet stations that allow for one pet to “go” indoors.

Pet stations have developed because hiding waste is a natural feline and canine instinct. Cats instinct of burying their waste stems from cats' long history of using urine and feces to mark their territory. Similarly, hiding waste is a natural behavior for dogs. Dogs cover up their waste so that an enemy does not find them from the scent of their waste. Due to these natural instincts to cover waste, most cats and dogs will take to disposing of their waste in litter provided in pet stations. But while it is natural for both cats and dogs to use a pet station with some form of cat or dog litter, cleaning and disposing of cat and dog waste and used litter is unpleasant and time consuming at best and unhealthy and physically challenging at worst. For example, scooping heavy used cat litter can be a challenge, particularly for older citizens. And the cost of scoopable cat litter is very high.

Pet stations are known. For example, the LitterMaid LM680C is an automatic self-cleaning litter box that has a drive mechanism and an automatic rake for easy cleaning of cat litter that is housed in a litter box. But use of the LitterMaid LM680C automatic self-cleaning litter box requires keeping the rake clean, as it comes in direct contact with waste. And the user still must scoop the waste and from time to time, the litter that must be replaced.

Litterworks provides a Litter-Bagger® for scoop free litter boxes, in an attempt to overcome the problems associated with keeping pet stations clean with a minimum of effort and health risks. The Litter-Bagger® LM980 is provided for scoop free litter boxes and is advertised to replace disposable crystal litter trays and bag litter waste for the user. The trouble with the Litterworks system, however, is that it requires a cardboard bag holder that is slid underneath and into and out of the wooden housing, and the tray that holds the litter and captures the waste still needs to be physically handled to dump the letter/waste into the bags.

### SUMMARY OF THE INVENTION

Broadly, the invention comprises a station at which pets may relieve themselves into a supply of litter, regardless of the pet species. The station comprises a top section that is substantially square, with a large square opening in the middle, i.e., there is no middle. The top section sits on a frame comprising three simple vertical sides, forming a semi-enclosed lower section, that is accessible from the top down via the opening of the top section. The top section is a hollow shell. The top section has a larger footprint than the lower section, so that the top section rests stably on the three vertical sides of the lower section. There is a plate that is removable, or a pair of removable plates, or a pair of movable plates, that are put in place co-planar with the lower planar dimension of the upper section, so that when in place, the plate or plates affect a bottom in the open middle part of the top section, essentially forming an upper chamber with the top section thereby.

The plate or plates formed what might be colloquially described as a “trap door” at the bottom of the upper section, and the top of the lower section. The litter (and waste) is provided in this chamber, with the plate or plates in place, such that when the plate or plates are removed, or allowed to flip 90 degrees down on a hinge or pair of hinges, the litter and waste can fall through, out of the top section and into the bottom section, whereinafter the plate or plates may be put back in place and clean litter provided. Please note, however, while some preferred embodiment implements the trap door by way of moveable, or removeable plates, the invention is not limited thereto. The trap door may be implemented using any means for forming a bottom in the upper section, where the bottom is removable or moveable. This could include a lover system, or multiple flap-based system, as should be clear to the skilled person.

While the litter and waste could be simply shoveled out of the inner volume of the lower section, preferably the litter/waste container is moved in and out of the inner volume into which the litter and waste drops when the plate or plates are removed or flipped away from the bottom of the upper section.

Preferably, the vertical sides of the bottom section, the top section and the plates are made of a sheet metal, like stainless steel or aluminum, but not limited thereto. The material may be any material as required to fit an end application, for example, any type of metal, plastic or wood. A container (e.g., a trash container) is included to slide or roll in and out of the bottom section, just below the top section, for capturing the litter and waste when the plate or plates are managed to allow same to fall through. Any various mechanisms known in the art for controlling the plate or plates to move into the opening between the bottom of the upper section and top of the bottom section is within the scope and spirit of the invention. For example, the plate or plate may be fixed to a handle or handles, so that the plate or plates are simply slid into place to close the opening and form a bottom part of a chamber, formed of the inner volume of the upper section.

Another simple embodiment is for a bearing member to slide in an out just under the plate, such that when in, the plate or plates rests on same, and when pulled out the plate or plates swivels and swings about 90 degrees down about a hinge and lifted back in place as the bearing member is slid back into place holding up the plates or plates. Alternatively, the plate or plates may be attached to handles, which when turned a fixed amount, releases and allows the plate and handle to follow an arcuate path in one or both vertical sides equivalent to about a quarter circle, so that the plates allow for their load of litter and waste to drop down into the lower section. For that matter, the plate or plates may be controlled to be maintained in place using a motor, whether battery operated DC motor and a AC motor that is plugged by wire into a 60 Hz 120-volt outlet.

The Pet Station is preferably manufactured in small, medium and large sizes, as now described, but can be custom-made. The trap door must be flat. The trap door and 4 sides act as the kitty box and should be 8″ to 16″ deep. The top surface of the upper section, between the outer edges and the inner edges of the opening, should be between 8″ and 16″ to allow the pets to comfortably navigate before the step in, and to have a stable platform to receive them when they step out. Small size=2′ length×2′ width, medium size=4′ length×4′ width, large size=6′ length×4′ or 6′ width, for many cats and/or dogs. The trap door, depending on the intended end application, should hold anywhere up to 160 pounds, since one or more cats and/or dogs may be standing thereon while they do their doo. The trap door when closed must have a tight fit so that it can be cleaned.

In an embodiment, the invention is a system for receiving, maintaining and disposing of waste from domesticated animals. The system comprises an upper section configured as a rectangular tube formed of sheet material, which defines outer surfaces of the rectangular tube, wherein inner surfaces of the rectangular tube define and surround an inner volume for holding and receiving litter and the domesticated animals that provide waste therein. A bottom section comprising three substantially rectangular planar members that are connected to each other at side edges such that the planar members are at substantially right angles to each other in an arrangement in which each of the members extends vertically upward to form sides of an enclosure embodying a rectangular inner volume that is open on one side and is open at a top of the enclosure that is formed of upper edges of the three planar members in the vertical arrangement; wherein a rectangular plate is included to be removably positioned at lower surfaces of the rectangular tube of the upper section, to form a bottom and lower boundary of the inner volume of the upper section.

Upon positioning the rectangular plate at the lower surfaces of the rectangular tube of the upper section, the rectangular plate defines and separates the inner volume of the top section from the inner volume of the bottom section. Upon removing the rectangular plate from the lower surfaces of the rectangular tube of the upper section, any litter, waste and other debris present in the inner volume of the top section falls or drops into the inner volume of the bottom section.

The system may further comprise a container having four substantially rectangular planar sides that are interconnected and arranged to extend vertically up from a substantially rectangular base thereby forming an inner volume open at a top defined by upper edges of the planar sides, wherein the container is configured to be moved into and out of the inner volume of the bottom section through the opening on the one side. The container is moved into and out of the inner volume of the bottom section. Upon removing the rectangular plate from the lower surfaces of the rectangular tube of the upper section, any litter, waste and other debris present in the inner volume of the top section falls or drops into the inner volume of the container if the container is present in the inner volume of the bottom section.

The rectangular plate is removably positioned by sliding horizontally into and out of the positioning at the lower surfaces of the rectangular tube of the upper section. The system may further include a second rectangular plate and wherein the rectangular plate and the second rectangular plates are removably positioned by sliding horizontally into and out of the positioning at the lower surfaces of the rectangular tube of the upper section. Preferably, the rectangular plate is hingedly connected to at least one lower edge of an inner side surface of the rectangular tube of the upper section and is removably positioned by use of a handle connected to a bearing element; wherein the bearing element is inserted via the handle to support the rectangular plate to form the bottom and lower boundary of the inner volume of the upper section; and wherein the bearing element is removed via the handle from under the plate to allow the plate to swivel downward about the hinge and allow any litter, waste and other debris thereon to fall into the inner volume of the lower section. The handle and the bearing member are positioned and maintained in one of the three, vertically arranged, substantially rectangular planar members of the lower section.

Also, the rectangular plate is hingedly connected to at least one of the lower edges of an inner side surface of the rectangular tube of the upper section, or a lower side surface of the rectangular tube of the upper section and is removably positioned by use of a handle connected to the plate that is latched in a horizontal position and unlatched to allow the plate to move from a horizontal position forming a bottom of the inner volume of the upper section, to a vertical position forming an opening between the inner volumes of the upper and lower sections. Preferably, the rectangular tube and the plate are made of sheet metal or hardened plastic. The sheet metal is between 4-gauge and 20-gauge sheet metal, for example, 10 gauge.

Also, the rectangular plate is hingedly connected to at least one of the lower edges of an inner side surface of the rectangular tube of the upper section and is removably positioned by use of a motor that is actuated by an electrical switch. The motor may comprise a hydraulic piston, wherein a rod of the hydraulic piston extends to put the plate in position to form the bottom and lower boundary of the inner volume of the upper section, and the rod of the hydraulic piston retracts to allow the plate to swing down substantially vertically down into the inner volume of the lower section, or the inner volume of the container if present in the inner volume of the lower section. The hydraulic piston and switch are positioned in a side wall of the lower section.

In an embodiment, the rectangular shape of the upper section is 2 foot by 2 foot, a depth of 6 inches, an upper surface width of 6 inches; wherein the lower section is between 6 and 18 inches in height, and has a footprint of less than 2 foot by 2 foot and wherein the plate when fixed in place as the bottom to the upper section is able to hold a weight of between 30 and 100 pounds.

In an embodiment, the rectangular shape of the upper section is 3 foot by 3 foot, a depth of 9 inches, an upper surface width of 9 inches; wherein the lower section is between 12 and 24 inches in height, and has a footprint of less than 3 foot by 3 foot and wherein the plate when fixed in place as the bottom to the upper section is able to hold a weight of between 40 and 130 pounds.

In an embodiment, the rectangular shape of the upper section is 4 foot by 4 foot, a depth of 12 inches, an upper surface width of 12 inches; wherein the lower section is between 18 and 30 inches in height, and has a footprint of less than 4 foot by 4 foot and wherein the plate when fixed in place as the bottom to the upper section is able to hold a weight of between 50 and 160 pounds.

A trash bag or liner may be used in the lower section to capture litter and waste and a trash bag or liner may be used in the container to capture litter and waste.

### DESCRIPTION OF THE DRAWINGS

Further features and advantages of the invention will become apparent from the description of embodiments that follows, with reference to the attached figures, wherein:

FIG. 1A depicts a perspective view of an embodiment to the invention;

FIG. 1B depicts a plate and handle combination that is used as removable bottom or trap door to separate the upper and lower sections of the FIG. 1A embodiment;

FIG. 1C depicts an arrangement for maintaining the plate as the removable bottom or trap door for the FIGS. 1A and 1B embodiment;

FIG. 2A depicts a top plan view of an alternative embodiment of the invention;

FIG. 2B depicts front view of the embodiment of the invention depicted in FIG. 2A;

FIG. 3A depicts a top plan view of an alternative embodiment of the invention;

FIG. 3B depicts front view of the embodiment of the invention depicted in FIG. 3A;

FIG. 3C depicts side view of the embodiment of the invention depicted in FIGS. 3A and 3B;

FIG. 4A depicts a top plan view of an alternative embodiment of the invention;

FIG. 4B depicts front view of the embodiment of the invention depicted in FIG. 4A; and

FIG. 4C depicts side view of the embodiment of the invention depicted in FIGS. 4A and 4B.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

A system for receiving, maintaining and disposing of waste from domesticated animals has an upper section formed of sheet material that defines an inner volume for holding and receiving litter and a bottom section that operates to support the upper section. The lower section includes an opening for access to inner volume of the lower section. A plate may be inserted in an opening between the inner volume of the upper section and the inner volume of the lower section, to form a bottom and lower boundary of the inner volume of the upper section. Upon removing the plate, any litter, waste and other debris present in the inner volume of the top section falls or drops into the inner volume of the bottom section.

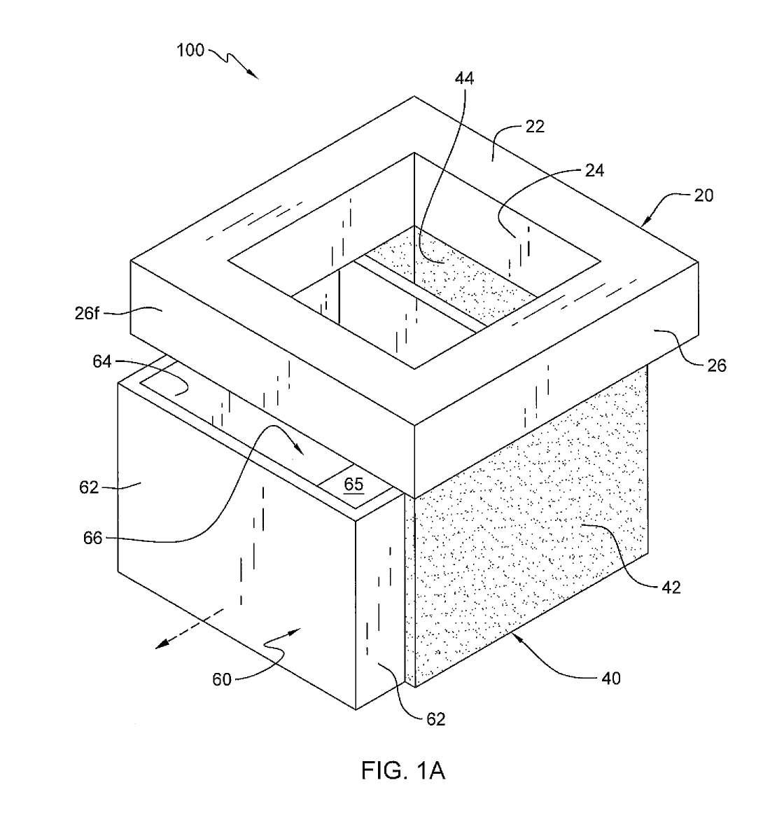

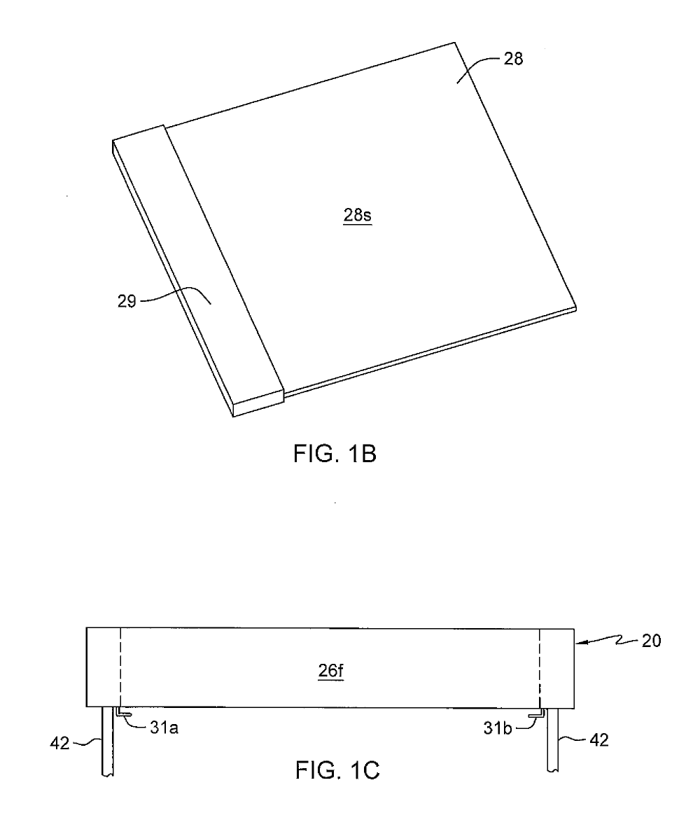

FIG. 1A presents one embodiment of the inventive pet station 100, which comprises three separate parts or sections, as shown. The station 100 comprises a top section 20 that embodies a rectangular tube comprising top side surfaces 22, inner side surfaces 24 and outer side surfaces 26 (including front side surface 26f). Bottom side surfaces, while not shown, are mirror images of the top side surfaces. While the rectangular tube is substantially square (with a large square opening in the middle), In the FIG. 1A embodiment as shown, the invention is not limited thereto. The top section can be any shape, for example, ring-shaped, triangular-shaped, pentagonal-shaped, hexagonally shaped, etc., as long as it has a depth and central opening sized to form an inner (top section) volume 23 that is large enough to hold an amount of litter and allow for pets to step into and relieve themselves on the litter. As will be explained in greater detail below, the lower extreme of the upper section must have one or more removable plates (see FIG. 1C) that when present, form a bottom or trap door, upon which the litter, waste, pets are upheld, thereby defining the lower extent of the inner volume (to be discussed in greater detail below). The plate 28 (or plates 28a, 28, in other embodiments), together with the inner side surfaces 24 of the upper section form the inner top-section volume 23. It follows that the shapes of the lower section and the litter/waste container, should follow the shape of the upper section and plate or plates forming the bottom thereto (to be discussed in greater detail below).

The top section 20 is arranged to be positioned on a bottom section 40 comprising three simple vertical sides 42, forming a semi-enclosed lower inner volume 44. The inner volume 44 of the bottom section is accessible from the top down via the opening forming the lower extend of the top section (when the plate or plates are not in place to form the trap door), as well as an open front (side), as shown. The lower section 40 essentially is a hollow shell with 3 vertical sides 42, and an opening in the front for receiving a litter/waste container 60, as shown. Litter/waste container 60, in the embodiment shown, is a rectangular container with four planar sides 62 and a bottom 65, that together form an inner container volume 66. The skilled person should note, however, that the container 60 may be formed in any particular shape to follow the shape of the top section 20 and lower section 40, which may vary from the rectangular shape of system 100, as explained above.

FIG. 1B shows one embodiment of the bottom or trap door, that is slid into place in the lower extent of the respective 4 sides (inner 24 and outer 26) of upper section 20. The movable bottom or trap door comprises a handle 29 attached to a plate 28. The plate is substantially planar and while preferably made of sheet metal, e.g., aluminum or steel, it is not limited thereto, but may be plastic, wood or other material capable of supporting the weight of pets and the litter and waste that are held in the inner volume 23, when the plate is in place as the bottom or trap door. A pair of flanges 31a, 31b, as can be seen in FIG. 1C, are formed in or affixed to the bottom surfaces of two opposing sides of the upper section 20. The flanges 31a, 31b are of sufficient height and strength to receive and maintain the plate 28 when the plate is slid in place, and loaded with a pet, litter and/or waste. The depth of the plate is between 0.02″ and 0.25″ which can vary to accommodate variations on an expected load on the plate, or material of which the plate is made.

The footprint of the plate 28 must be larger than the opening formed by the four inner walls of the top section, so that when slid in place, the handle 29 and plate 28 close the lower opening of the top section 20. The position of the flanges 31a, 31b, must be arranged to accommodate the width of the plate 28. The upper extent of the sides 62 of the litter/waste container 60 must be such that they are of a height that is slightly less than the vertical location of the plate 28 in the combined system. That is, the upper dimension of the container must be such that it may be moved in and out of inner volume 44 of the lower section 40 when the handle 29 and plate 28 are fixed in place at the planar bottom of the upper section 20.

The top section 20 has a larger footprint than the lower section 40, so that the lower surfaces of the top section rest stably on the three vertical sides 42 of the lower section 40. The location of the flanges 31a, 31b, must be located more central to the inner volume than the aforementioned contact points of the vertical sides 42 to the lower surface of the upper section Indentations for receiving the top edges of the sides 42 of the bottom section may be formed in the lower side surfaces of the top section 20 (not shown in FIG. 1). Moreover, a brush, or other mechanism for pressing against and cleaning a top surface 28s of the plate 28 as it is removed from its fully inserted position whereat it completely fills the opening, to form the inner volume 23, is preferably included and fixed to the lower edge of front side surface 26f. As such, the plate 28 is drawn against the brush as it is removed, causing any litter, waste or other debris that might otherwise stick to the surface 28s of the plate to fall into the inner volume 44 of the lower section, and preferably, into the inner volume 66 of the container 60 when the container itself is position in the inner volume 44.

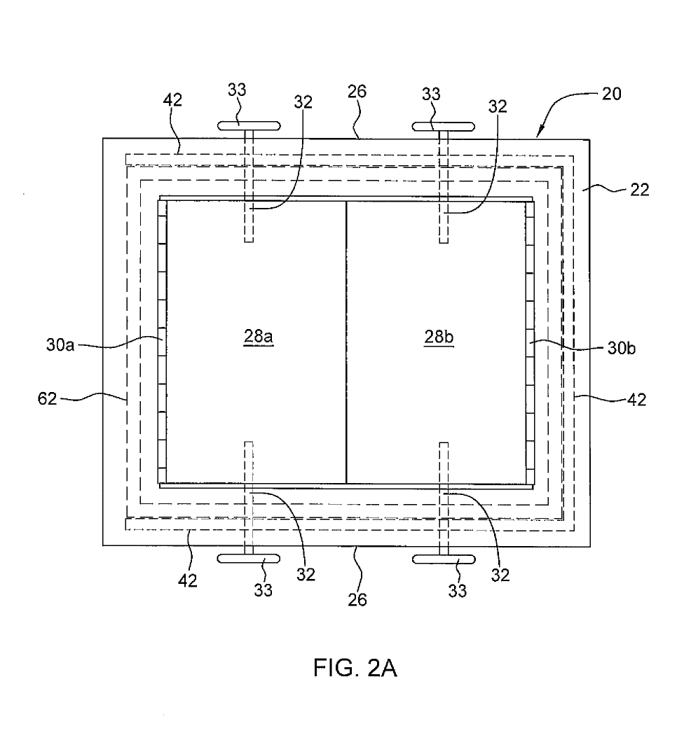

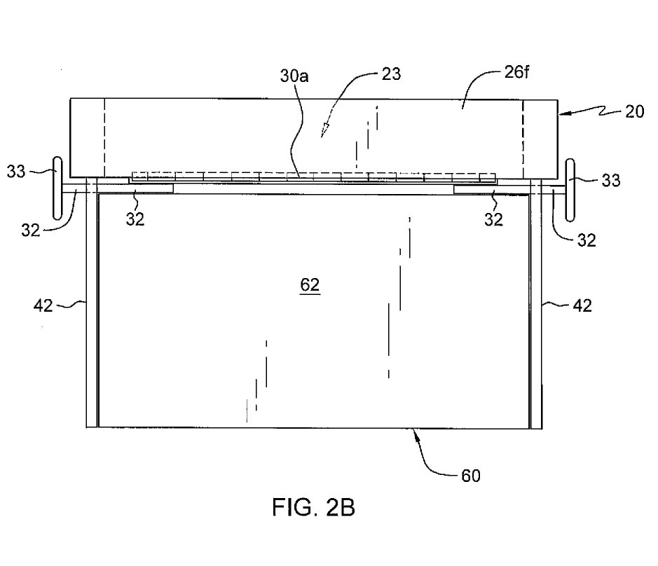

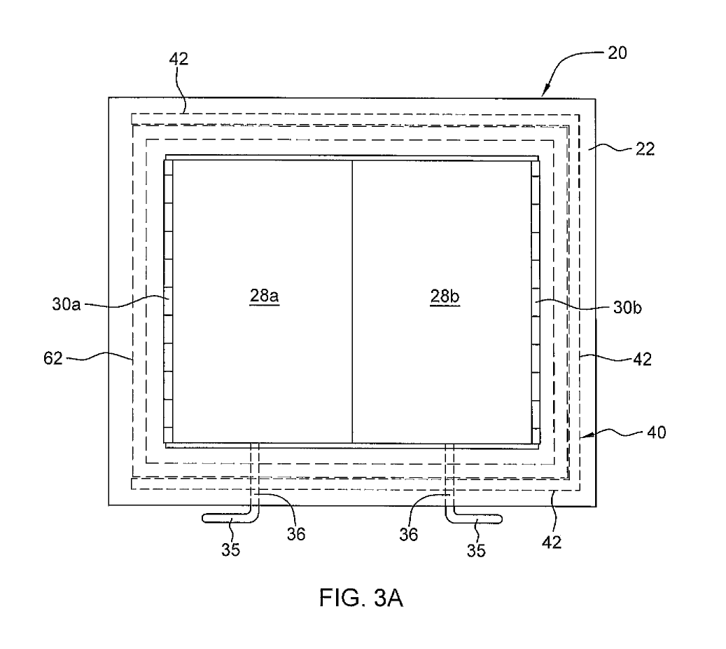

The embodiment of FIGS. 2A and 2B show a plates 28a, 28b that are removably positioned at the lower portion of the upper section 20, or at the upper portion of the lower section 40, to form a trap door bottom to the upper section. The two opposing vertical sides 42 of the lower section 40 are configured to include handles 33, and bearing surfaces 32 extending therefrom, that are moved in towards the inner volume of the lower section (just above the top of the litter container 60 to prevent interference therewith) so that the plates 28a, 28b bear thereupon. The plates 28a, 29b, are attached by hinges 30a, 30b, to the upper edges of the opposing vertical sides 42 of the lower section 40. Removing the handles and bearing surfaces allows the plates to swing down about the hinges, by gravity, dumping the litter/waste preferably into the inner volume of the container 60. FIG. 2B shows the front side section 62 of the container 60.

When the removable plates 28a, 28b, are present and positioned in place, it/they, together with the inner side surfaces 24 of the top section 20, form an inner volume 23 that holds the litter, any pets that may enter therein and any waste the pets may excrete or expel. The plates are arranged to be co-planar with the lower side surfaces of the upper section 20. When the plates 28a, 28b, are removed, or allowed to flip 90 degrees down on a hinge or pair of hinges, the litter and waste can fall through, out of the top section 20 and into the bottom section 40, whereinafter the plates may be put back in place and clean litter provided in the inner volume 23.

When the plates 28a, 28b are put back in position to form the removable or moveable bottom of the inner volume 28 of the upper section 20, they form a substantially tight fit, where preferably, the fit seals against liquids flowing through to the inner volume 44 of the lower section 40. For that matter, the plates (or plate in the case of a single-plate embodiment) may be cleaned in the open, substantially vertical, downward-facing position or instead, in the fixed position as the bottom of the inner volume 23 of the upper section. The plate or plates, and the sides of the inner volume 23 of the upper section 20, may be cleaned by any means known to those of ordinary skill in the art. For that matter, the plate or plates may be removed to effect cleaning, and returned in either position, post cleaning.

Once allowed to fall into the inner volume 44 of the lower section 40, the litter and waste could be simply shoveled out. But the invention instead envisions a litter/waste container 60, that is moved into and out of the inner volume 44 of the lower section 40, for capturing the litter/waste, when the plate 28 or plates 28a, 28b are removed or flipped away from the bottom of the upper section 20. And any various mechanisms known in the art for controlling the plate 28 or plates 28a, 28b to move into the opening between the bottom of the upper section and top of the bottom section is within the scope and spirit of the invention.

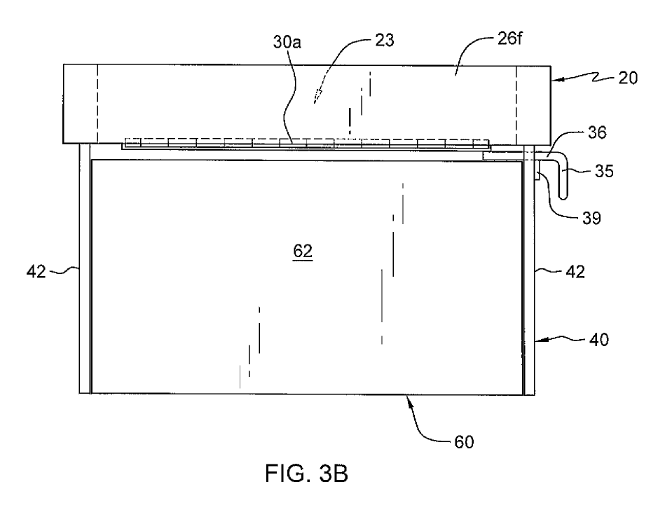

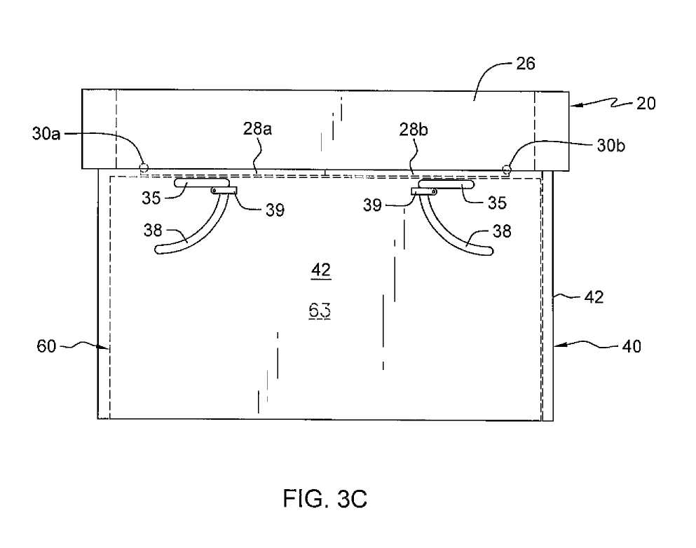

For example, the plate or plates may be fixed to a handle or handles, so that the plate or plates are simply slid or turned into place to close the opening and form a bottom part of a chamber formed as the inner volume 23, using the handle or handles (see FIGS. 3A-C and description of same below). For that matter, the plate or plates may be operated to turn downwards to release the litter and waste held thereon and returned to the position in which they form the trap door platform, using any of: an electric motor, a hydraulic motor or a hydraulic piston. The only requirement for the aforementioned means is that they are sufficient to move the plate or plates into and out of the support position, in the bottom of the upper section 20. An electrical switch is included to control operation of the electric motor, hydraulic motor or hydraulic piston. For that matter, even a hand crank and associated lifting mechanism could be used to effect movement of the plate or plates, into and out of the opening, avoiding the need for the electric motor, hydraulic motor or hydraulic piston and electrical switch for controlling operation of same.

Once the plate 28 or plates 28a, 28b, are returned from an open (downward) position, back to the position where it or they are fixed in place to form the bottom of the inner volume.

Turning back to FIG. 1A, the litter/waste container 60 is box-like with a bottom (not shown), four outer sides 62, and four inner sides 64 that together form an inner volume 66. When the lifter/waste container 60 is positioned in the lower section 40, the inner volume 66 of the litter/waste container coincides with the inner volume 44 of the lower section 40. Preferably, the inner volume 28 of the upper section 20 is slightly smaller in length and width, i.e., has a smaller footprint, that the inner volume 44 of the lower section and the inner volume 66 of the litter/waste container 60. Of course, the inner volume 66 of the lifter/waste container 60 may be lined, for example, with a trash bag or liner of appropriate size. The container 60 is preferably configured to simply slide or roll in and out of the bottom section, just below the top section. The container, however, may include wheels for that purpose, or may have one portion of a slide mechanism, configured to cooperate with a complementary slide mechanism built into the sides 42 of the lower section 40.

FIGS. 3A, 3B and 3C together depict an alternative embodiment for implementing the trap door at the top of the lower section 40, to control the state of the inner volume 23 of the upper section 20, and therefore, the opening to. When the plates 28a, 28b are in place, the inner volume 23 is formed and maintained. When the plates are removed from their in-place position as the bottom, the litter waste therein is allowed to pass through and into the container volume 66/inner volume of the lower section 40. As shown, handles 35 are mounted in one of the opposing side 42 of the lower section. Each handle includes a longitudinal member 36 that extends into the inner volume of the lower section to connect or be coupled to the respective plates 28a, 28b, as shown. The handles include a latch 39 that operates to maintain the handles, and, therefore, the plates, stably in their upper position (see FIG. 3C), to maintain the inner volume and contain the pets, litter and/or waste, until unlatched. Once unlatched, the handles, longitudinal members and plates are allowed to follow or traverse respective paths 38 down, guided or tempered by the user's (hand) hold on the handle. At the lowest point in the paths 38, the plates are essentially vertical, as distinguished from their substantially horizontal position when in place to hold the letter/waste.

The vertical sides 42 of the bottom section 40, the sides forming all the surfaces of the top section 20 and the plate 28 or plates 28a, 28b are made of a sheet metal, like stainless steel or aluminum, but not limited thereto. The material may be any material as required to fit an end application, for example, any type of metal, plastic or wood.

In all the embodiments, the rectangular tube comprising the upper section 20 of litter/waste container 100 should be slightly larger than the plate or plates forming the trap door, so that when the plate(s) are moved/removed, there is no spillage of the lifter/waste sitting thereon (in the inner volume of the upper section). For this purpose, the container 60 preferably has a handle on the outside to pull out and push in to the inner volume of the lower section 40. The litter/waste container 60 can be on rollers, so to easily slid out and in. The litter/waste container preferably is 2′ deep but must have clearance to slide in and out with a garbage bag, without interfering with the mechanism for controlling the plate (“trap door”) operation. In one embodiment, the vertical sides 42 are 2′ high, the upper section 20 is about 1′ high so that the aggregate height of the entire station 100, when together is about 3 feet.

For that matter, the ledge created by the top surface of the upper section, between the outer side vertical surfaces, and the inner side vertical surfaces that face/form the inner volume, is preferably 2 to 8 inches wide, but preferably at least 6″ wide, to accommodate the pets with minimal risk that they will slip of and into the litter or slip off onto the outside of the station. In a preferred embodiment, removable steps made of wood with carpet covering leading from the side on the Pet Station should be able to be attached to the ledge surround. The removable steps, for example, can be sold separately from the upper section, lower section and litter/waste container.

As mentioned, a hand lever for controlling the plate or plates (trap door) can be replaced with electrical switch driven electrical motor. The electrical switch/motor combination operates to move the plate of plates into and out of place thereby implementing the trap door function. For that matter, and electrical motor may be included to move the litter/waste container into and out of its place. And preferably, the Kitty box (i.e., the chamber or inner volume of the upper section 20 holding the litter and waste) can be made with a cover. The cover will be able to clasp onto the kitty box and can be easily removed or installed.

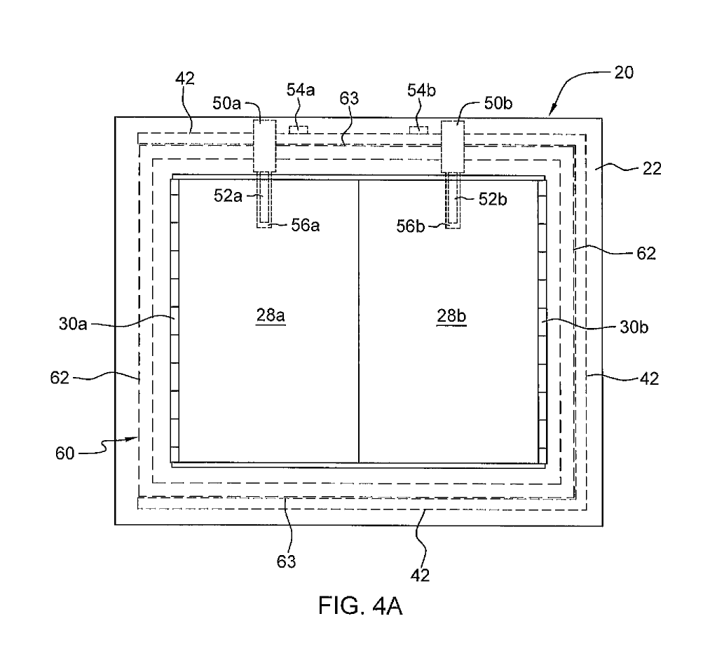

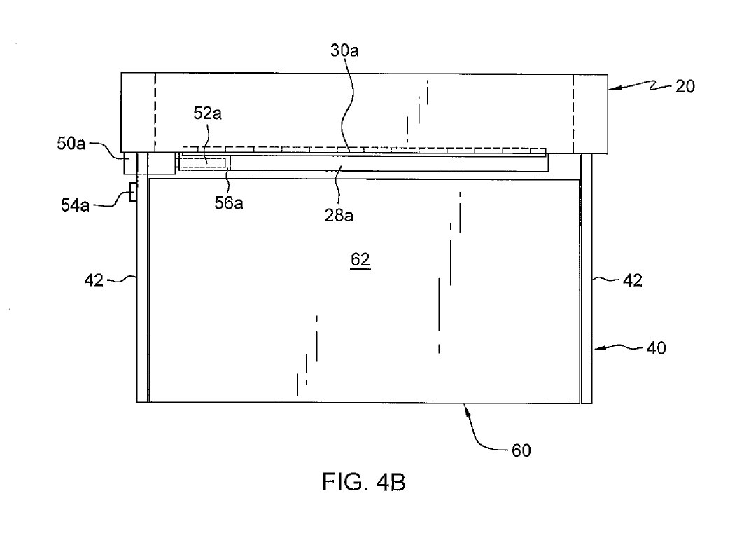

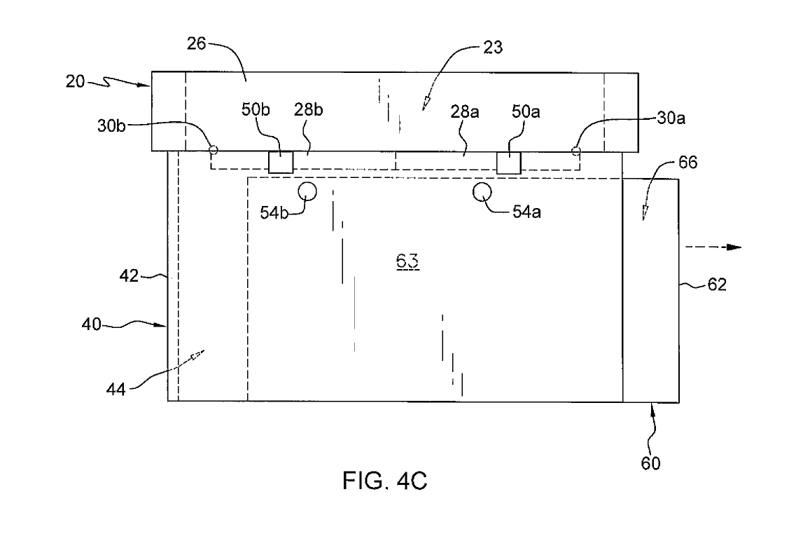

FIGS. 4A, 4B and 4C depict another embodiment of the invention, that automatically raises and releases the plates 28a, 28b. FIG. 4A shows respective hydraulic pistons 50a, 50b, coupled to plates 28a, 28b, respectively, via piston rods 52a, 52b. When activated by pushing respective push-button switches 54a, 54b, the rods 52a, 52b extend out of the hydraulic pistons (housings) 50a, 50b, and extend along slots 56a, 56b, on the underside of the plates, thereby raising them up into place as the trap door (i.e., as the planar bottom of the inner volume 23 of the upper section, formed with the four side walls 24).

When the push-button switches are toggled, the piston rods 52a, 52b, retract to allow the plates to swivel down to a position in which the planar surfaces (that form the bottom of the inner volume, when in place) are substantially vertical, and substantially coplanar with two opposing inner sides 24 of the upper section. Moving down into these vertical positions acts to dump the litter and waste either into the inner volume 44 of the lower section 40, or into the inner volume 66 of the litter/waste container 60, when it is in place in the lower section. FIG. 4B shows a front view of the system that highlights, on the left, the piston 50a and rod 52a and on the right, the piston 50b and the rod 52b. FIG. 4C shows the system from the side.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A system for receiving, maintaining and disposing of waste from domesticated animals, comprising:
an upper section configured as a rectangular tube formed of sheet material, which defines outer surfaces of the rectangular tube, wherein inner surfaces of the rectangular tube define and surround an inner volume for holding and receiving litter and the domesticated animals that provide waste therein; and
a bottom section comprising three substantially rectangular planar members that are connected to each other at side edges such that the planar members are at substantially right angles to each other in an arrangement in which each of the members extends vertically upward to form sides of an enclosure embodying a rectangular inner volume that is open on one side and is open at a top of the enclosure that is formed of upper edges of the three planar members in the vertical arrangement; wherein a rectangular plate is included to be removably positioned at lower surfaces of the rectangular tube of the upper section, to form a bottom and lower boundary of the inner volume of the upper section;
wherein upon positioning the rectangular plate at the lower surfaces of the rectangular tube of the upper section, the rectangular plate defines and separates the inner volume of the top section from the inner volume of the bottom section; and
wherein upon removing the rectangular plate from the lower surfaces of the rectangular tube of the upper section, any litter, waste and other debris present in the inner volume of the top section falls or drops into the inner volume of the bottom section.

2. The system as set forth in claim 1, further comprising a container having four substantially rectangular planar sides that are interconnected and arranged to extend vertically up from a substantially rectangular base thereby forming an inner volume open at a top defined by upper edges of the planar sides, wherein the container is configured to be moved into and out of the inner volume of the bottom section through the opening on the one side;
wherein the container is moved into and out of the inner volume of the bottom section; and
wherein upon removing the rectangular plate from the lower surfaces of the rectangular tube of the upper section, any litter, waste and other debris present in the inner volume of the top section falls or drops into the inner volume of the container if the container is present in the inner volume of the bottom section.

3. The system as set forth in claim 1, wherein the rectangular plate is removably positioned by sliding horizontally into and out of the positioning at the lower surfaces of the rectangular tube of the upper section.

4. The system as set forth in claim 1, further including a second rectangular plate and wherein the rectangular plate and the second rectangular plates are removably positioned by sliding horizontally into and out of the positioning at the lower surfaces of the rectangular tube of the upper section.

5. The system as set forth in claim 1, wherein the rectangular plate is hingedly connected to at least one lower edge of an inner side surface of the rectangular tube of the upper section and is removably positioned by use of a handle connected to a bearing element; wherein the bearing element is inserted via the handle to support the rectangular plate to form the bottom and lower boundary of the inner volume of the upper section; and wherein the bearing element is removed via the handle from under the plate to allow the plate to swivel downward about the hinge and allow any litter, waste and other debris thereon to fall into the inner volume of the lower section.

6. The system as set forth in claim 5, wherein the handle and the bearing member are positioned and maintained in one of the three, vertically arranged, substantially rectangular planar member of the lower section.

7. The system as set forth in claim 1, wherein the rectangular plate is hingedly connected to at least one of the lower edges of an inner side surface of the rectangular tube of the upper section, or a lower side surface of the rectangular tube of the upper section and is removably positioned by use of a handle connected to the plate that is latched in a horizontal position and unlatched to allow the plate to move from a horizontal position forming a bottom of the inner volume of the upper section, to a vertical position forming an opening between the inner volumes of the upper and lower sections.

8. The system as set forth in claim 7, wherein the rectangular tube and the plate are made of sheet metal or hardened plastic.

9. The system as set forth in claim 8, wherein the sheet metal is between 4-gauge and 20-gauge sheet metal.

10. The system as set forth in claim 8, wherein the sheet metal is 10 gauge.

11. The system as set forth in claim 1, wherein the rectangular plate is hingedly connected to at least one of the lower edges of an inner side surface of the rectangular tube of the upper section and is removably positioned by use of a motor that is actuated by an electrical switch.

12. The system as set forth in claim 11, wherein the motor comprises a hydraulic piston.

13. The system as set forth in claim 12, wherein a rod of the hydraulic piston extends to put the plate in position to form the bottom and lower boundary of the inner volume of the upper section, and the rod of the hydraulic piston retracts to allow the plate to swing down substantially vertically down into the inner volume of the lower section, or the inner volume of the container if present in the inner volume of the lower section.

14. The system as set forth in claim 13, wherein the hydraulic piston and switch are positioned in a side wall of the lower section.

15. The system as set forth in claim 1, wherein the rectangular shape of the upper section is 2 foot by 2 foot, a depth of 6 inches, an upper surface width of 6 inches; wherein the lower section is between 6 and 18 inches in height, and has a footprint of less than 2 foot by 2 foot and wherein the plate when fixed in place as the bottom to the upper section is able to hold a weight of between 30 and 100 pounds.

16. The system as set forth in claim 1, wherein the rectangular shape of the upper section is 3 foot by 3 foot, a depth of 9 inches, an upper surface width of 9 inches; wherein the lower section is between 12 and 24 inches in height, and has a footprint of less than 3 foot by 3 foot and wherein the plate when fixed in place as the bottom to the upper section is able to hold a weight of between 40 and 130 pounds.

17. The system as set forth in claim 1, wherein the rectangular shape of the upper section is 4 foot by 4 foot, a depth of 12 inches, an upper surface width of 12 inches; wherein the lower section is between 18 and 30 inches in height, and has a footprint of less than 4 foot by 4 foot and wherein the plate when fixed in place as the bottom to the upper section is able to hold a weight of between 50 and 160 pounds.

18. The system as set forth in claim 1, wherein a trash bag or liner may be used in the lower section to capture litter and waste.

19. The system as set forth in claim 2, wherein a trash bag or liner may be used in the container to capture litter and waste.
